(19) United States
(12) Patent Application Publication
(10) Pub. No.: US 2023/0231109 A1
(43) Pub. Date: Jul. 20, 2023

(54) NEGATIVE ELECTRODE FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventors: Kyunghwa JUNG, Yongin-si (KR); Yunshik CHO, Yongin-si (KR); Seunghyun OH, Yongin-si (KR); Minho CHO, Yongin-si (KR); Kukjoo LEE, Yongin-si (KR); Jungmin LEE, Yongin-si (KR)

(21) Appl. No.: 18/098,626

(22) Filed: Jan. 18, 2023

(30) Foreign Application Priority Data
Jan. 20, 2022 (KR) 10-2022-0008685

(51) Int. Cl. H01M 4/36; H01M 4/38; H01M 4/62; H01M 10/052; H01M 4/587

(52) U.S. Cl. CPC H01M 4/364; H01M 4/386; H01M 4/622; H01M 10/052; H01M 4/587; H01M 2004/027

(57) ABSTRACT

A negative electrode for a rechargeable lithium battery and a rechargeable lithium battery including the same are disclosed. The negative electrode may include a silicon-based negative active material and a binder, where the binder is an acryl-based copolymer, the acryl-based copolymer including an acrylic acid first monomer, an acrylonitrile second monomer, and a (meth)acrylate third monomer. The acrylic acid first monomer may include acrylic acid substituted with lithium ions. The (meth)acrylate third monomer may include an ethylene glycol group, and a weight-average molecular weight (Mw) of the (meth)acrylate third monomer is less than about 900 g/mol.

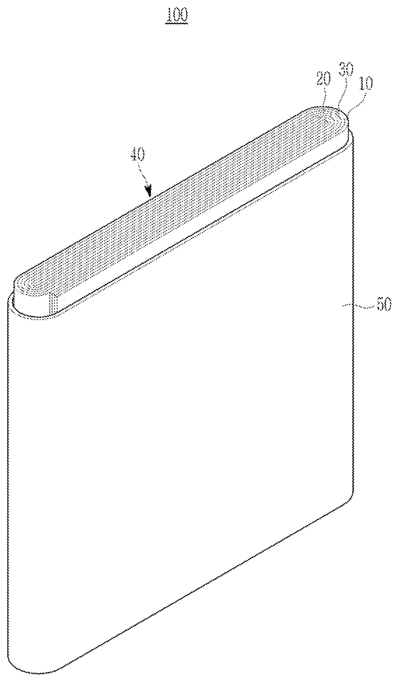

### CROSS-REFERENCE TO RELATED APPLICATION

This application claims priority to and the benefit of Korean Patent Application No. 10-2022-0008685, filed in the Korean Intellectual Property Office on Jan. 20, 2022, the entire content of which is incorporated herein by reference.

### BACKGROUND

### 1. Field

One or more embodiments of the present disclosure relate to a negative electrode for a rechargeable lithium battery and a rechargeable lithium battery including the same.

### 2. Description of the Related Art

Recently, with the increase in demand for automotive batteries, silicon-containing negative active materials have been drawing much attention due to their capability to improve current density and charge capacity of rechargeable lithium batteries utilized in automobiles. However, for such silicon-containing negative active materials, contraction and expansion of silicon occurred during charging and discharging may cause the volume change of the electrode, which weakens and/or breaks the binding between the active material particles or between the active material and a current collector (supporting the active material), resulting in that the active material does not function properly, thereby decreasing charge and discharge capacities of the battery.

Therefore, developing a binder for reducing expansion of the electrode, which inhibits breakage of the electrode structure caused by charge and discharge, is highly desired. Furthermore, to improve the battery performances, rechargeable lithium batteries being capable of raid charging are actively investigated. Generally, the rapid charging may reduce the cycle-life of the battery and thus, capacity of the battery. To address these issues, there is a need to develop a low resistance binder for a negative electrode.

The above information disclosed in this Background section is only for enhancement of understanding of the background of the present disclosure, and therefore it may contain information that does not form the prior art.

### SUMMARY

One or more aspects of embodiments of the present disclosure are directed toward a negative electrode for a rechargeable lithium battery which may minimize or reduce the volume change of the negative electrode occurred during charge and discharge and reduce the resistance of the battery, thereby exhibiting or providing excellent or suitable cycle-life characteristic and excellent or suitable power characteristic.

One or more aspects of embodiments of the present disclosure are directed toward a rechargeable lithium battery including the negative electrode.

Additional aspects will be set forth in part in the description which follows and, in part, will be apparent from the description, or may be learned by practice of the presented embodiments of the disclosure.

According to one or more embodiments of the present disclosure, a negative electrode for a rechargeable lithium battery may include a silicon-based negative active material and a binder, where the binder is an acryl-based copolymer, and the acryl-based copolymer may include an acrylic acid first monomer, an acrylonitrile second monomer, and a (meth)acrylate third monomer. The acrylic acid first monomer may include acrylic acid substituted with a lithium ion, the (meth)acrylate third monomer may include an ethylene glycol group, and a weight-average molecular weight (Mw) of the (meth)acrylate third monomer is less than about 900 g/mol.

In one or more embodiments, the weight-average molecular weight (Mw) of the (meth)acrylate third monomer may be about 300 g/mol to about 600 g/mol.

In one or more embodiments, the acrylic acid (AA) substituted with the lithium ion may have a substitution degree of lithium ion (Li/AA) of about 40 mol % to about 80 mol %.

In one or more embodiments, a weight ratio of the acrylic acid first monomer, the acrylonitrile second monomer, and the (meth)acrylate third monomer may be about 60 to 25:40:5 to 35 by weight.

In one or more embodiments, an amount of the (meth)acrylate third monomer may be about 5 wt % to about 30 wt % based on the total weight, 100 wt %, of the acrylic acid first monomer, the acrylonitrile second monomer, and the (meth)acrylate third monomer.

In one or more embodiments, the (meth)acrylate third monomer may be a polyethylene glycol methyl ether methacrylate monomer.

In one or more embodiments, the silicon-based active material may include silicon and carbon.

According to one or more embodiments of the present disclosure, a rechargeable lithium battery is provided to include the negative electrode, a positive electrode, and an electrolyte.

The negative electrode according to one or more embodiments of the present disclosure may exhibit excellent or suitable cycle-life characteristics and excellent or suitable high-rate charge and discharge characteristics when utilized in a rechargeable lithium battery.

### BRIEF DESCRIPTION OF THE DRAWING

The accompanying drawing is included to provide a further understanding of the present disclosure, and is incorporated in and constitutes a part of this specification. The drawing illustrates example embodiments of the present disclosure and, together with the description, serves to explain principles of present disclosure. In the drawing:

The drawing illustrates a schematic diagram showing a rechargeable lithium battery according to one or more embodiments of the present disclosure.

### DETAILED DESCRIPTION

The present disclosure may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure.

Hereinafter, embodiments of the present disclosure are described in more detail. However, these embodiments are merely examples, the present disclosure is not limited thereto, and the present disclosure is defined by the scope of claims.

In the present disclosure, when a definition is not otherwise provided, such a particle diameter or size (D50) indicates an average particle diameter or size (D50) where a cumulative volume is about 50 volume % in a particle size distribution. Also, in the present specification, when particles are spherical, “diameter” indicates a particle diameter or an average particle diameter, and when the particles are non-spherical, the “diameter” indicates a major axis length or an average major axis length.

The average particle diameter or size (D50) may be measured by a method suitable to those skilled in the art, for example, by a particle size analyzer, or also by a transmission electron microscopic image or a scanning electron microscopic image. In some embodiments, a dynamic light-scattering measurement device may be utilized to perform a data analysis, and the number of particles is counted for each particle size range. From the data, the average particle diameter/size (D50) value may be easily obtained through a calculation.

The terms utilized below are only utilized to describe specific embodiments and are not intended to limit the present disclosure. Singular expressions may include plural expressions unless the context clearly indicates otherwise. Hereinafter, it will be further understood that the terms “comprise,” “include,” or “have” when utilized in the present disclosure, specify the presence of stated features, integers, steps, operations, elements, and/or components, but do not preclude the presence or addition of one or more other features, integers, steps, operations, elements, components, and/or groups thereof. As utilized herein, the terms “and/or” and “or” may include any and all combinations of one or more of the associated listed items. The “/” utilized herein may be interpreted as “and” or as “or” depending on the situation.

A negative electrode for a rechargeable lithium battery according to one or more embodiments of the present disclosure may include a silicon-based negative active material and a binder. The binder may be an acryl-based copolymer, and the acryl-based copolymer may include an acrylic acid first monomer, an acrylonitrile second monomer, and a (meth)acrylate third monomer.

The “(meth)” may include a methyl group, or may not include a methyl group. For example, (meth)acrylate may be an acrylate or may be a methacrylate.

The acrylic acid first monomer may include acrylic acid substituted with lithium ions. The acrylic acid substituted with the lithium ions may refer to lithium acrylate including “—COOH” and in which hydrogen of “—COOH” included is substituted with lithium.

The inclusion of the acrylic acid substituted with the lithium ions may reduce electrical resistance of the negative electrode.

In one or more embodiments, the acrylic acid first monomer may include acrylic acid substituted with the lithium ions at an amount of about 40 mol % to about 80 mol % based on the total, 100 mol %, of the acrylic acid. For example, the acrylic acid substituted with the lithium ions may have a substitution degree of lithium ion (Li/AA) of about 40 mol % to about 80 mol %. When the acrylic acid substituted with the lithium ions is included at this range of mol %, the reduction in resistance may be further improved.

When an element belonging to Group 1 of the Periodic Table, rather than lithium, is utilized, for example, acrylic acid substituted with sodium ions is utilized, the result is not desired or suitable, as the effect for reducing resistance is not significant.

In one or more embodiments, the (meth)acrylate third monomer may be a (meth)acrylate monomer including an ethylene glycol group, and a weight-average molecular weight (Mw) of the (meth)acrylate third monomer may be less than about 900 g/mol. In some embodiments, the weight-average molecular weight (Mw) of the (meth)acrylate third monomer may be about 300 g/mol to about 600 g/mol. When the weight-average molecular weight (Mw) of the (meth)acrylate third monomer is less than 900 g/mol, fluidity of the binder is good or suitable, thereby reducing resistance and improving movement of lithium.

For example, in one or more embodiments, the (meth)acrylate monomer including an ethylene glycol group may be polyethylene glycol methyl ether methacrylate monomer.

In the copolymer according to one or more embodiments of the present disclosure, a weight ratio of the acrylic acid first monomer, the acrylonitrile second monomer, and the (meth)acrylate third monomer may be about 60 to 25:40:5 to 35 by weight, or about 55 to 30:40:5 to 30 by weight.

An amount of the acrylic acid first monomer may be about 25 wt % to about 60 wt % based on the total weight, 100 wt %, of the acrylic acid first monomer, the acrylonitrile second monomer, and the (meth)acrylate third monomer. Furthermore, an amount of the acrylonitrile second monomer may be about 30 wt % to about 50 wt % based on 100 wt % of the acrylic acid first monomer, the acrylonitrile second monomer, and the (meth)acrylate third monomer.

When the weight ratio of the acrylic acid first monomer, the acrylonitrile second monomer, and the (meth)acrylate third monomer, or the amounts of the acrylic acid first monomer and the acrylonitrile second monomer are within the ranges described above, the obtained copolymer may have suitable water-solubility, so that the processability of the negative electrode preparation utilizing the copolymer may be secured and the resistance of the negative electrode may be effectively reduced.

In some embodiments, an amount of the (meth)acrylate third monomer may be about 5 wt % to about 30 wt %, or about 5 wt % to about 20 wt %, based on the total weight, 100 wt %, of the acrylic acid first monomer, the acrylonitrile second monomer, and the (meth)acrylate third monomer. In the copolymer, when the amount of the (meth)acrylate third monomer is satisfied in the above range, the cycle-life and power characteristics of the negative electrode may be further improved.

The copolymer according to one or more embodiments of the present disclosure may be prepared by copolymerizing acrylic acid, acrylonitrile, and a (meth)acrylate monomer, and the copolymerization may be carried out by any techniques well-suitable in the related arts.

It may be effective and beneficial to utilize the binder according to one or more embodiments of the present disclosure together with the silicon-based negative active material. The silicon-based negative active material is utilized to improve current density and increase capacity of the rechargeable lithium battery, but the silicon-based negative active material has severe volume expansion issues during charge and discharge compared to a carbon-based active material. However, the binder according to one or more embodiments of the present disclosure may effectively suppress or reduce the volume expansion, so that the severe volume expansion of the silicon-based negative active material is effectively suppressed or reduced.

In one or more embodiments, the silicon-based negative active material may include silicon and carbon. The carbon may be crystalline carbon or amorphous carbon. The crystalline carbon may be natural graphite, artificial graphite, or a combination thereof. The amorphous carbon may be soft carbon, hard carbon, mesophase pitch carbide, sintered cokes, or a combination thereof.

In one or more embodiments, the silicon-based negative active material may include a silicon-based material and amorphous carbon, or may include crystalline carbon, a silicon-based material, and amorphous carbon. In one or more embodiments, the silicon-based material may be silicon (Si) or a silicon oxide (SiOₓ, 0<x<2).

When the silicon-based negative active material includes a silicon-based material and amorphous carbon, it may be an agglomerated product of the silicon-based material and amorphous carbon, or a silicon-based material coated with amorphous carbon. In some embodiments, a mixing ratio of the silicon-based material and amorphous carbon may be about 1:99 to about 60:40 by weight.

In some embodiments, when the silicon-based negative active material includes crystalline carbon, a silicon-based material, and amorphous carbon, it may be an aggregate of aggregating the crystalline carbon and the silicon-based material, coated with an amorphous carbon. In some embodiments, an amount of the silicon-based material may be about 1 wt % to about 60 wt %, in some embodiments, about 3 wt % to about 60 wt %, based on 100 wt % of the total silicon-based negative active material. In the silicon-based negative active material, an amount of the amorphous carbon may be about 20 wt % to about 60 wt % based on 100 wt % of the silicon-based negative active material, and an amount of the crystalline carbon may be about 20 wt % to about 60 wt % based on 100 wt % of the silicon-based negative active material.

In one or more embodiments, in the negative electrode, the negative active material may further include a carbon-based negative active material, together with the silicon-based negative active material. When the silicon-based negative active material is utilized together with the carbon-based negative active material, a mixing ratio of the silicon-based negative active material and the carbon-based negative active material may be about 1:99 to about 50:50 by weight. In some embodiments, a mixing ratio of the silicon-based negative active material and the carbon-based negative active material may be about 5:95 to about 20:80 by weight.

The carbon-based negative active material may be graphite such as unspecified shaped, sheet shaped, flake shaped, spherical shaped, or fiber shaped natural graphite or artificial graphite, and/or amorphous carbon. The amorphous carbon may be soft carbon, hard carbon, mesophase pitch carbide, sintered cokes, and/or the like.

In one or more embodiments, the negative electrode may include a negative active material layer including the negative active material and a binder, and a current collector supported thereon.

In one or more embodiments, the negative active material layer may further include a conductive material.

In the negative active material layer, an amount of the negative active material may be about 95 wt % to about 98 wt % based on the total weight, 100 wt %, of the negative active material layer. An amount of the binder may be about 1 wt % to about 5 wt % based on the total weight, 100 wt %, of the negative active material layer. An amount of the conductive material may be about 1 wt % to about 5 wt % based on the total weight, 100 wt %, of the negative active material layer.

As the binder, the binder according to one or more embodiments of the present disclosure may be a first binder, and an aqueous binder may be further included as a second binder together with the first binder. Even though the binder includes the first binder and the second binder, an total amount of the binder may be about 1 wt % to about 5 wt % based on the total weight, 100 wt %, of the negative active material layer. When the binder includes the first binder and the second binder, a mixing ratio of the first binder and the second binder may be about 70:30 to about 40:60 by weight. When the mixing ratio of the first binder and the second binder is within the above range, the negative electrode having excellent or suitable flexibility adherence may be prepared.

The aqueous binder may be a styrene-butadiene rubber (SBR), an acrylated styrene-butadiene rubber (ABR), an acrylonitrile-butadiene rubber, an acryl rubber, a butyl rubber, or a combination thereof.

The conductive material may be included to provide electrical conductivity for the negative electrode, and any suitable electrically conductive material may be utilized as a conductive material unless it causes a chemical change. Non-limiting examples of the conductive material may include: a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof, but is not limited thereto.

In one or more embodiments, a rechargeable lithium battery may include the negative electrode, a positive electrode, and an electrolyte.

The positive electrode may include a current collector and a positive active material layer including a positive active material and formed on the current collector.

The positive active material may include lithiated intercalation compounds that reversibly intercalate and deintercalate lithium ions. For example, one or more composite oxides of a metal selected from cobalt, manganese, nickel, and a combination thereof, and lithium, may be utilized as the positive active material. In one or more embodiments, the positive active material may include a compound represented by one of the following chemical formulae: LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.5, 0<α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0≤e≤0.1); LiₐNi_{b}Co_{c}Al_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8).

In the above chemical formulae, A is selected from nickel (Ni), cobalt (Co), manganese (Mn), and a combination thereof; X is selected from aluminum (Al), Ni, Co, Mn, chromium (Cr), iron (Fe), magnesium (Mg), strontium (Sr), vanadium (V), a rare earth element, and a combination thereof; D is selected from oxygen (O), fluorine (F), sulfur (S), phosphorous (P), and a combination thereof; E is selected from Co, Mn, and a combination thereof; T is selected from F, S, P, and a combination thereof; G is selected from Al, Cr, Mn, Fe, Mg, lanthanum (La), cerium (Ce), Sr, V, and a combination thereof; Q is selected from titanium (Ti), molybdenum (Mo), Mn, and a combination thereof; Z is selected from Cr, V, Fe, scandium (Sc), yttrium (Y), and a combination thereof; and J is selected from V, Cr, Mn, Co, Ni, copper (Cu), and a combination thereof.

In one or more embodiments, the compound may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, potassium (K), sodium (Na), calcium (Ca), silicon (Si), Ti, V, tin (Sn), germanium (Ge), gallium (Ga), boron (B), arsenic (As), zirconium (Zr), or a mixture thereof. The coating layer may be disposed by a method having no adverse influence on properties of the positive active material by utilizing these elements in the compound. For example, the method may include any coating method such as spray coating, dipping, and/or the like, but will not be illustrated in more detail herein because it is well-utilized in the related field.

In the positive electrode, an amount of the positive active material may be about 90 wt % to about 98 wt % based on the total weight of the positive active material layer.

In one or more embodiments of the present disclosure, the positive active material layer may further include a binder and a conductive material. Herein, the binder and the conductive material may each be included in an amount of about 1 wt % to about 5 wt % based on the total amount of the positive active material layer.

The binder improves binding properties of positive active material particles with one another and with the current collector. Non-limiting examples of the binder may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene butadiene rubber, acrylated styrene butadiene rubber, an epoxy resin, nylon, and/or the like, but embodiments of the present disclosure are not limited thereto.

The conductive material may be included to provide electrical conductivity for the positive electrode, and any electrically conductive material may be utilized as a conductive material unless it causes a chemical change. Non-limiting examples of the conductive material may include: a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; or a mixture thereof.

The current collector may utilize aluminum foil, nickel foil, or a combination thereof, but embodiments of the present disclosure are not limited thereto.

The electrolyte may include a non-aqueous organic solvent and a lithium salt.

The non-aqueous organic solvent serves as a medium for transmitting/transporting ions taking part in the electrochemical reaction of the battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone and/or the like. The alcohol-based solvent may include ethyl alcohol, isopropyl alcohol, and/or the like, and non-limiting examples of the aprotic solvent may include nitriles such as R—CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, and/or the like.

The non-aqueous organic solvent may be utilized alone or in a mixture. When the non-aqueous organic solvent is utilized in a mixture, the mixture ratio may be controlled or selected in accordance with a desired battery performance, and it may be well suitable to one in related art.

In some embodiments, the carbonate-based solvent may desirably include a mixture of a cyclic carbonate and a linear carbonate. The cyclic carbonate and the linear carbonate may be mixed together in a volume ratio of about 1:1 to about 1:9, and when the mixture is utilized as an electrolyte, it may have enhanced performance.

In one or more embodiments, the non-aqueous organic solvent may further include an aromatic hydrocarbon-based solvent as well as the carbonate-based solvent. The carbonate-based solvent and the aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

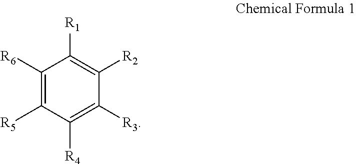

In Chemical Formula 1, R₁ to R₆ may be the same or different, and may each independently be selected from among hydrogen, a halogen, a C1 to C10 alkyl group, a haloalkyl group, and a combination thereof.

Non-limiting examples of the aromatic hydrocarbon-based organic solvent may be selected from among benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

In one or more embodiments, the electrolyte may further include vinyl ethyl carbonate, vinylene carbonate, or an ethylene carbonate-based compound represented by Chemical Formula 2, as an additive, for improving cycle life of the battery.

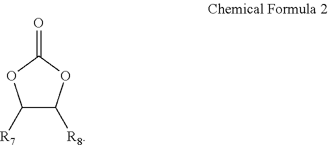

In Chemical Formula 2, R₇ and R₈ may be the same or different and may each independently be hydrogen, a halogen, a cyano group (CN), a nitro group (NO₂), or a C1 to C5 fluoroalkyl group, provided that at least one selected from among R₇ and R₈ is a halogen, a cyano group (CN), a nitro group (NO₂), or a C1 to C5 fluoroalkyl group, and R₇ and R₈ are not concurrently (e.g., simultaneously) hydrogen.

Non-limiting examples of the ethylene carbonate-based compound may be difluoro ethylene carbonate, chloroethylene carbonate, dichloroethylene carbonate, bromoethylene carbonate, dibromoethylene carbonate, nitroethylene carbonate, cyanoethylene carbonate, or fluoroethylene carbonate, and/or the like. An amount of the additive for improving the cycle-life characteristics of the battery may be utilized within an appropriate or suitable range.

The lithium salt dissolved in the non-aqueous organic solvent supplies the battery with lithium ions, sustains a basic operation of the rechargeable lithium battery, and improves transportation of the lithium ions between the positive electrode and the negative electrode. Non-limiting examples of the lithium salt may include at least one or two supporting salts selected from among LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), (wherein x and y are natural numbers, for example, an integer of about 1 to about 20), lithium difluoro(bisoxolato) phosphate, LiCl, LiI, LiB(C₂O₄)₂ (lithium bis(oxalato) borate: LiBOB), and lithium difluoro(oxalato)borate (LiDFOB). A concentration of the lithium salt may be in a range of about 0.1 M to about 2.0 M. When the lithium salt is included at the above concentration range, the electrolyte may have excellent or suitable performance and lithium ion mobility due to optimal or suitable electrolyte conductivity and viscosity.

A separator may be disposed between the positive electrode and the negative electrode depending on a type or kind of a rechargeable lithium battery. The separator may utilize polyethylene, polypropylene, polyvinylidene fluoride, or multi-layers thereof having two or more layers, and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

The drawing illustrates an exploded perspective view of a rechargeable lithium battery according to one or more embodiments of the present disclosure. The rechargeable lithium battery according to one or more embodiments of the present disclosure is illustrated as a prismatic battery, but embodiments of the present disclosure are not limited thereto, and may include variously shaped batteries such as a cylindrical battery, a pouch battery, and/or the like.

Referring to the drawing, in one or more embodiments, a rechargeable lithium battery 100 may include an electrode assembly 40 manufactured by winding a separator 30 disposed between a positive electrode 10 and a negative electrode 20 and a case 50 housing the electrode assembly 40. An electrolyte may be impregnated in the positive electrode 10, the negative electrode 20, and the separator 30.

Hereinafter, examples of the present disclosure and comparative examples are described. These examples, however, should not in any sense to be interpreted as limiting the scope of the present disclosure.

### Example 1

An acrylic acid (AA) first monomer, an acrylonitrile (AN) second monomer, a polyethylene glycol methyl ether methacrylate (PEGMA, weight-average molecular weight (Mw)=300 g/mol) third monomer were added to a reactor to have an amount of 45 wt %, 40 wt %, and 15 wt %, respectively, and a VA-086 initiator (Wako Pure Chemical Industries Ltd), an AR-1025 emulsifier (DKS Co. Ltd.), and water were added to the reactor to proceed a copolymerization reaction.

Lithium hydroxide was added to the resulting copolymerization reaction product and agitated to prepare a binder aqueous solution including a copolymer of the acrylic acid first monomer, the acrylonitrile second monomer, and the PEGMA third monomer. Herein, an amount of lithium hydroxide utilized was adjusted to substitute 60 mol % of the acrylic acid first monomer with lithium ions, and thus the resulting product was prepared as a copolymer binder including lithium polyacrylate in which 60 mol % of an acrylic group included in the acrylic acid first monomer was substituted with lithium ions.

The binder aqueous solution had viscosity of 2670 cps at 25° C. based on 6 wt % of a solid content (e.g., amount). The viscosity was measured using a Brookfield Viscometer with LV4 Spindle at 30 rpm and a room temperature (25° C.).

97.4 wt % of a negative active material, 1.2 wt % of the binder aqueous solution, and 1.4 wt % of styrene-butadiene rubber were mixed to prepare a negative active material slurry. The negative active material was a mixed active material of a blending of artificial/natural graphite and a silicon-carbon composite (mixing ratio of 90:10 by weight). The silicon-carbon composite included an agglomerated product in which artificial graphite and silicon nanoparticles are agglomerated and a soft carbon coating layer on the surface of the agglomerated product. An amount of artificial graphite was 40 wt %, an amount of the silicon nanoparticles was 40 wt %, and an amount of the soft carbon was 20 wt %, based on the total weight of the silicon-carbon composite.

The negative active material slurry was coated on a copper current collector and dried, followed by pressing to prepare a negative electrode.

### Example 2

A binder aqueous solution having viscosity of 2740 cps at 25° C. based on 6 wt % of a solid content (e.g., amount) was prepared by substantially the same procedure as in Example 1, except that a PEGMA third monomer having a weight-average molecular weight (Mw) of 500 g/mol was utilized as the PEGMA third monomer.

Using (utilizing) the binder aqueous solution, a negative electrode was prepared by substantially the same procedure as in Example 1.

### Comparative Example 1

A binder aqueous solution having viscosity of 2620 cps at 25° C. based on 6 wt % of a solid content (e.g., amount) was prepared by substantially the same procedure as in Example 1, except that a PEGMA third monomer having a weight-average molecular weight (Mw) of 900 g/mol was utilized as the PEGMA third monomer.

Using the binder aqueous solution, a negative electrode was prepared by substantially the same procedure as in Example 1.

### Comparative Example 2

A binder aqueous solution having viscosity of 2690 cps at 25° C. based on 6 wt % of a solid content (e.g., amount) was prepared by substantially the same procedure as in Example 1, except that a PEGMA third monomer having a weight-average molecular weight (Mw) of 1500 g/mol was utilized as the PEGMA third monomer.

Using the binder aqueous solution, a negative electrode was prepared by substantially the same procedure as in Example 1.

### Example 3

A binder aqueous solution having viscosity of 2600 cps at 25° C. based on 6 wt % of a solid content (e.g., amount) was prepared by substantially the same procedure as in Example 2, except that an amount of lithium hydroxide was adjusted and utilized to substitute 40 mol % of the acrylic acid first monomer with lithium ions.

Using the binder aqueous solution, a negative electrode was prepared by substantially the same procedure as in Example 1.

### Example 4

A binder aqueous solution having viscosity of 2690 cps at 25° C. based on 6 wt % of a solid content (e.g., amount) was prepared by substantially the same procedure as in Example 2, except that an amount of lithium hydroxide was adjusted and utilized to substitute 80 mol % of the acrylic acid first monomer with lithium ions.

Using the binder aqueous solution, a negative electrode was prepared by substantially the same procedure as in Example 1.

### Comparative Example 3

A binder aqueous solution was prepared by substantially the same procedure as in Example 2, except that an amount of lithium hydroxide was adjusted and utilized to substitute 30 mol % of the acrylic acid first monomer with lithium ions. As the prepared binder solution was non-water-soluble, it was impossible to measure the viscosity, and thus the subsequent experiments were not performed.

### Comparative Example 4

A binder aqueous solution having viscosity of 2750 cps at 25° C. based on 6 wt % of a solid content (e.g., amount) was prepared by substantially the same procedure as in Example 2, except that an amount of lithium hydroxide was adjusted and utilized to substitute 90 mol % of the acrylic acid first monomer with lithium ions.

Using the binder aqueous solution, a negative electrode was prepared by substantially the same procedure as in Example 1.

### Example 5

A binder aqueous solution having viscosity of 2850 cps at 25° C. based on 6 wt % of a solid content (e.g., amount) was prepared by substantially the same procedure as in Example 2, except that an acrylic acid (AA) first monomer, an acrylonitrile (AN) second monomer, and a PEGMA (weight-average molecular weight (Mw)=500 g/mol) third monomer were utilized to have an amount of 55 wt %, 40 wt %, and 5 wt %, respectively.

Using the binder aqueous solution, a negative electrode was prepared by substantially the same procedure as in Example 1.

### Example 6

A binder aqueous solution having viscosity of 2260 cps at 25° C. based on 6 wt % of a solid content (e.g., amount) was prepared by substantially the same procedure as in Example 2, except that an acrylic acid (AA) first monomer, an acrylonitrile (AN) second monomer, and a PEGMA (weight-average molecular weight (Mw)=500 g/mol) third monomer, were utilized to have an amount of 30 wt %, 40 wt %, and 30 wt %, respectively.

Using the binder aqueous solution, a negative electrode was prepared by substantially the same procedure as in Example 1.

### Comparative Example 5

A binder aqueous solution having viscosity of 2820 cps at 25° C. based on 6 wt % of a solid content (e.g., amount) was prepared by substantially the same procedure as in Example 2, except that an acrylic acid (AA) first monomer, an acrylonitrile (AN) second monomer, and a PEGMA (weight-average molecular weight (Mw)=500 g/mol) third monomer were utilized to have an amount of 60 wt %, 40 wt %, and 0 wt %, respectively.

Using the binder aqueous solution, a negative electrode was prepared by substantially the same procedure as in Example 1.

### Reference Example 1

A binder aqueous solution having viscosity of 1990 cps at 25° C. based on 6 wt % of a solid content (e.g., amount) was prepared by substantially the same procedure as in Example 2, except that an acrylic acid (AA) first monomer, an acrylonitrile (AN) second monomer, and a PEGMA (weight-average molecular weight (Mw)=500 g/mol) third monomer were utilized to have an amount of 20 wt %, 40 wt %, and 40 wt %, respectively.

Using the binder aqueous solution, a negative electrode was prepared by substantially the same procedure as in Example 1.

### Comparative Example 6

Sodium hydroxide was added to the copolymerization reaction product according to Example 1 and agitated to prepare a binder aqueous solution including a copolymer of an acrylic acid first monomer, an acrylonitrile second monomer, and a PEGMA third monomer. A utilized amount of sodium hydroxide was adjusted to substitute 60 mol % of the acrylic acid first monomer with sodium ions, and thus, the resulting product was prepared as a copolymer binder including sodium polyacrylate in which 60 mol % of an acrylic group included in the acrylic acid first monomer was substituted with sodium ions.

Using the binder aqueous solution, a negative electrode was prepared by substantially the same procedure as in Example 1.

### Comparative Example 7

97.7 wt % of the negative active material utilized in Example 1, 1.4 wt % of a styrene butadiene rubber binder, and 0.9 wt % of a carboxymethyl cellulose thickener were mixed in a water solvent to prepare a negative active material slurry.

The negative active material slurry was coated on a copper current collector and dried, followed by pressing to prepare a negative electrode.

### (Preparation Example) Fabrication of a Half-Cell

Utilizing each negative electrode of Examples 1 to 6, Comparative Examples 1 to 7, and Reference Example 1, a lithium metal counter electrode, and an electrolyte, a coin-type or kind half-cell was fabricated. As the electrolyte, 1.5 M LiPF₆ dissolved in ethylene carbonate, ethylmethyl carbonate, and dimethyl carbonate (20:10:70 volume ratio) was utilized.

### Experimental Example 1) Evaluation of Expansion Ratio of Negative Electrode

The half-cell was standard charged and discharged at 0.1 C once. A ratio of thickness of the negative electrode after the standard charge and discharge to an initial thickness of the negative electrode before the standard charge and discharge was measured. The results are shown in Table 1, as an expansion ratio of the negative electrode.

### Experimental Example 2) Evaluation of Specific Resistance of Negative Electrode

Specific resistances of the negative electrodes of Examples 1 to 6, Comparative Examples 1 to 7, and Reference Example 1 were measured by a resistance meter available from HIOKI, Co. Ltd. (resistance value measured in the vertical direction of negative electrode (e.g., in a thickness direction of negative electrode), through a plane). The results are shown in Table 1.

### Experimental Example 3) Evaluation of Lithium Deposition Amount

The half-cell was charged and discharged at 0.2 C once, and then disassembled to separate the negative electrode. In the separated negative electrode, an amount of the deposited lithium was measured and obtained by utilizing an inductively coupled plasma mass analysis device (ICP-MS). The lithium deposition amount was calculated as a percentage value based on 100 wt % of the negative active material. The results are shown in Table 1.

### Experimental Example 4) Evaluation of Cycle-Life

The half-cell was charged and discharged at 0.33 C at room temperature of 25° C. for 100 cycles. A ratio of the 100^{th} discharge capacity to the 1^{st} discharge capacity was obtained. The results are shown in Table 1, as capacity retention.

TABLE 1

| | Negative | Negative | | |
|---|---|---|---|---|
| | electrode | electrode | Li | |
| | expansion | specific | deposition | Capacity |
| | ratio (%) | resistance (Ωm) | amount (%) | retention (%) |
| Example 1 | 12.8 | 0.22 | 0.81 | 86 |
| Example 2 | 12.9 | 0.21 | 0.79 | 88 |
| Comparative | 12.9 | 0.23 | 0.84 | 84 |
| Example 1 | | | | |
| Comparative | 12.8 | 0.26 | 1.05 | 82 |
| Example 2 | | | | |
| Example 3 | 13.6 | 0.23 | 0.81 | 86 |
| Example 4 | 12.9 | 0.20 | 0.76 | 87 |
| Comparative | non-water- | — | — | — |
| Example 3 | soluble | | | |
| Comparative | 13.5 | 0.23 | 0.83 | 83.7 |
| Example 4 | | | | |
| Example 5 | 12.7 | 0.23 | 0.84 | 86 |
| Example 6 | 13.8 | 0.16 | 0.74 | 86 |
| Comparative | 12.6 | 0.26 | 1.10 | 81 |
| Example 5 | | | | |
| Reference | 16.4 | 0.14 | 0.71 | 77 |
| Example 1 | | | | |
| Comparative | 12.9 | 0.28 | 1.35 | 82 |
| Example 6 | | | | |
| Comparative | 15.1 | 0.26 | 1.12 | 78 |
| Example 7 | | | | |

As shown in Table 1, the negative electrode including the binder of each of Examples 1 to 6 maintained an expansion ratio of the negative electrode, with decreased specific resistance and lithium deposition amount (e.g., slightly), and surprisingly improved capacity retention.

Whereas, Comparative Example 1 including the binder utilizing the (meth)acrylate third monomer having a weight-average molecular weight (Mw) of 900 g/mol, exhibited a high lithium deposition amount and low capacity retention. Comparative Example 2 including the binder utilizing the (meth)acrylate third monomer having a weight-average molecular weight (Mw) of 1500 g/mol, exhibited high specific resistance, a very high lithium deposition amount, and significantly low capacity retention.

Comparative Example 4 utilizing the binder having a high substitution degree of lithium ions of 90 mol % exhibited high negative electrode specific resistance, a high lithium deposition amount, and low capacity retention.

Comparative Example 5 including the binder prepared without the (meth)acrylate third monomer, and Comparative Example 6 utilizing the binder substituted with sodium ions, rather than lithium ions, exhibited an excessively high negative electrode specific resistance and an excessively high lithium deposition amount and significantly deteriorated capacity retention.

Comparative Example 7 utilizing the styrene butadiene rubber binder, rather than the copolymer binder of the present disclosure exhibited high negative electrode specific resistance, a high lithium deposition amount, and significantly deteriorated capacity retention.

Reference Example 1 in which the utilized amount of the first monomer was low at 20 wt %, exhibited low specific resistance and a low lithium deposition amount, but excessively deteriorated capacity retention.

In addition, even with charge and discharge for 100 cycles as shown in Table 1, the capacity retention of Examples 1 to 6 exhibited higher than Comparative Examples 1 to 7, so that it can be expected that the long cycle-life, for example, capacity retention after charge and discharge for 500 cycles in examples, is significantly improved compared to the comparative examples.

Throughout the disclosure, when a component such as a layer, a film, a region, or a plate is mentioned to be placed “on” another component, it will be understood that it may be directly on another component or that another component may be interposed therebetween.

Throughout the disclosure, although the terms “first”, “second”, “third”, etc., may be utilized herein to describe one or more elements, components, regions, and/or layers, these elements, components, regions, and/or layers should not be limited by these terms. These terms are only utilized to distinguish one component from another component.

As utilized herein, the singular forms “a,” “an,” and “the” are intended to include the plural forms as well, unless the context clearly indicates otherwise. Further, the use of “may” when describing embodiments of the present disclosure may refer to “one or more embodiments of the present disclosure”.

As utilized herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While the present disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims and equivalents thereof.

What is claimed is:

1. A negative electrode for a rechargeable lithium battery, the negative electrode comprising:
a silicon-based negative active material; and
a binder,
wherein the binder is an acryl-based copolymer, and the acryl-based copolymer comprises an acrylic acid first monomer, an acrylonitrile second monomer, and a (meth)acrylate third monomer,
the acrylic acid first monomer comprises an acrylic acid (AA) substituted with a lithium ion, and
the (meth)acrylate third monomer comprises an ethylene glycol group and has a weight-average molecular weight (Mw) less than about 900 g/mol.

2. The negative electrode of claim 1, wherein the weight-average molecular weight (Mw) of the (meth)acrylate third monomer is about 300 g/mol to about 600 g/mol.

3. The negative electrode of claim 1, wherein the acrylic acid substituted with the lithium ion has a substitution degree of lithium ion (Li/AA) of about 40 mol % to about 80 mol %.

4. The negative electrode of claim 1, wherein a weight ratio of the acrylic acid first monomer, the acrylonitrile second monomer and the (meth)acrylate third monomer is about 60 to 25:40:5 to 35 by weight.

5. The negative electrode of claim 1, wherein an amount of the (meth)acrylate third monomer is about 5 wt % to about 30 wt % based on the total weight, 100 wt %, of the acrylic acid first monomer, the acrylonitrile second monomer, and the (meth)acrylate third monomer.

6. The negative electrode of claim 1, wherein the (meth)acrylate third monomer is a polyethylene glycol methyl ether methacrylate monomer.

7. The negative electrode of claim 1, wherein the silicon-based negative active material comprises silicon and carbon.

8. A rechargeable lithium battery, comprising:
the negative electrode of claim 1;
a positive electrode; and
an electrolyte.

9. The rechargeable lithium battery of claim 8, wherein the weight-average molecular weight (Mw) of the (meth)acrylate third monomer is about 300 g/mol to about 600 g/mol.

10. The rechargeable lithium battery of claim 8, wherein the acrylic acid substituted with the lithium ion has a substitution degree of lithium ion (Li/AA) of about 40 mol % to about 80 mol %.

11. The rechargeable lithium battery of claim 8, wherein a weight ratio of the acrylic acid first monomer, the acrylonitrile second monomer and the (meth)acrylate third monomer is about 60 to 25:40:5 to 35 by weight.

12. The rechargeable lithium battery of claim 8, wherein an amount of the (meth)acrylate third monomer is about 5 wt % to about 30 wt % based on the total weight, 100 wt %, of the acrylic acid first monomer, the acrylonitrile second monomer, and the (meth)acrylate third monomer.

13. The rechargeable lithium battery of claim 8, wherein the (meth)acrylate third monomer is a polyethylene glycol methyl ether methacrylate monomer.

14. The rechargeable lithium battery of claim 8, wherein the silicon-based negative active material comprises silicon and carbon.

15. The negative electrode of claim 1, wherein the binder is a first binder, and the negative electrode further comprises a second binder, and wherein the second binder is an aqueous binder selected from among a styrene-butadiene rubber (SBR), an acrylated styrene-butadiene rubber (ABR), an acrylonitrile-butadiene rubber, an acryl rubber, a butyl rubber, and a combination thereof.

16. The negative electrode of claim 15, wherein a mixing ratio of the first binder and the second binder is about 70:30 to about 40:60 by weight.

17. The negative electrode of claim 1, further comprising a carbon-based negative active material.

18. The rechargeable lithium battery of claim 8, wherein the binder is a first binder, and the negative electrode further comprises a second binder, and wherein the second binder is an aqueous binder selected from among a styrene-butadiene rubber (SBR), an acrylated styrene-butadiene rubber (ABR), an acrylonitrile-butadiene rubber, an acryl rubber, a butyl rubber, and a combination thereof.

19. The rechargeable lithium battery of claim 18, wherein a mixing ratio of the first binder and the second binder is about 70:30 to about 40:60 by weight.

20. The rechargeable lithium battery of claim 8, wherein the negative electrode further comprises a carbon-based negative active material.
